(19) United States
(12) Patent Application Publication
(10) Pub. No.: US 2024/0396637 A1
(43) Pub. Date: Nov. 28, 2024

(54) OPTICAL BEAMFORMING AND INTERFEROMETRY USING DIGITAL SOURCE MODULATION

(71) Applicant: NATIONAL RESEARCH COUNCIL OF CANADA, Ottawa (CA)

(72) Inventors: Brent CARLSON, Penticton (CA); Glen HERRIOT, Victoria (CA)

(21) Appl. No.: 18/693,746

(22) PCT Filed: Sep. 19, 2022
(86) PCT No.: PCT/IB2022/058835

§ 371 Date: Mar. 20, 2024

Related U.S. Application Data
(60) Provisional application No. 63/246,346, filed on Sep. 21, 2021.

(51) Int. Cl. H04B 10/50; H04B 10/118; H04B 10/516; H04J 14/02

(52) U.S. Cl. CPC H04B 10/503; H04B 10/118; H04B 10/516; H04J 14/02

(57) ABSTRACT

A system and method are provided for optical beamforming and interferometry using digital source modulation. In one aspect, a digitally-modulated calibration signal is included in the optical target source, for use by receiving mirrors and equipment to continuously lock onto, track, and remove atmospheric and instrumental temporal distortion effects. By using this digitally-modulated calibration signal throughout the optical signal chain any variations that both it and the science/pay load signal undergo can be removed, leading to lower cost optical mirrors and optical interferometers, as well as allowing for larger optical apertures

### FIELD OF THE INVENTION

The present disclosure relates generally to radio astronomy digital signal processing and timing. More particularly, examples of the disclosure relate to a system and method for optical beamforming and interferometry using digital source modulation.

### BACKGROUND OF THE DISCLOSURE

Large mirrors and adaptive optics using wavefront sensing and deformable mirrors, and optical interferometry with complex and expensive mirror-mirror (i.e. “baseline-based”) sidereal delay tracking, are known for high spatial resolution applications such as optical astronomy and satellite-to-Earth (downlink) and Earth-to-satellite (uplink) free-space optical communications (“sat-comm”.)

However, single large optical mirrors are expensive and subject to a fundamental limit due to gravitational bending effects of large, massive, mechanical structures. Additionally, atmospheric turbulence across the aperture of an optical mirror requires the use of electro-mechanical adaptive optics. The number of mirrors in an optical interferometer is limited due to baseline-based sidereal delay tracking. The size of an optical interferometer array (i.e. the “array aperture”) is limited due to the requirement for precision optics required for coordinating all of the mirrors. Sat-comm is subject to complexity/limitations of downlink and uplink adaptive optics and cost and size of mirrors.

Any discussion of problems provided in this section has been included in this disclosure solely for the purposes of providing a background for the present invention, and should not be taken as an admission that any or all of the discussion was known at the time the invention was made.

### BRIEF DESCRIPTION OF THE DRAWING FIGURES

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements and wherein:

FIG. 1 illustrates a system for optical beamforming and interferometry using digital source modulation, in accordance with exemplary embodiments of the disclosure.

FIG. 2 shows sub-aperture calibration using digital source modulation, in accordance with exemplary embodiments of the disclosure.

FIG. 3 shows an exemplary station reference clock and DSM message decoder of the system depicted in FIG. 1.

FIG. 4 shows an exemplary per-sub-aperture PID servo of the system depicted in FIG. 1.

FIG. 5 shows an exemplary DAC/ADC block of the per-sub-aperture PID servo of the system depicted in FIG. 4.

FIG. 6 shows a system for station beam offset for astronomical applications, in accordance with exemplary embodiments of the disclosure.

FIG. 7 illustrates a system for optical astronomy aperture synthesis (interferometry), in accordance with exemplary embodiments of the disclosure.

FIG. 8 shows an exemplary lag correlator of the system depicted in FIG. 7.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present disclosure.

### DETAILED DESCRIPTION OF EXEMPLARY EMBODIMENTS

As discussed below, a system and method are provided for optical beamforming and interferometry using digital source modulation. In one aspect, a digitally-modulated calibration signal, referred herein to as “Digital Source Modulation” (DSM), is included in the optical target source, for use by receiving mirrors and equipment to continuously lock onto, track, and remove atmospheric and instrumental temporal distortion effects. By using this digitally-modulated calibration signal throughout the optical signal chain any variations that both it and the science/payload signal undergo can be removed, leading to lower cost optical mirrors and optical interferometers, as well as allowing for larger optical apertures.

For sat-comm, the DSM signal can be one optical colour of a Dense Wavelength Division Multiplexing (DWDM) signal, with the other colours of the DWDM signal being high data rate communications “payload”.

For astronomy, the DSM signal can be a laser signal transmitted by one or more optical “Satellite Guide Stars” (SGS), each with an orbit that allows a sufficient period of time close to the science target to be used as a calibrator.

For both sat-comm and astronomy, the DSM calibration signal can be ON/OFF modulation of an optical monochromatic carrier, wherein the modulation contains signaling to allow synchronized production, at each receiving element, of a high-purity complex digital monochromatic signal (i.e. “tone”), referred to herein as a “tracer.” Since the DSM calibration signal comes from a source that is common to all receiving elements, and follows the identical or nearly identical optical path as the science or payload signal, any delay differences in the DSM at each receiving element, which are removed before further beamforming (summing) and/or interferometer (multiply-accumulate) operations, also therefore apply to the science or payload signal.

Since both the DSM optical carrier and encoded digital signal (tracer) are monochromatic, the DSM fundamentally forms the highest SNR (signal-to-noise ratio) calibrator signal possible since all calibration signal power is concentrated into a very narrow bandwidth.

According to an aspect of this specification, a system is provided for optical beamforming and interferometry using digital source modulation, comprising a plurality of sub-apertures, including a reference sub-aperture, for receiving and transmitting a digital source modulation (DSM) signal and payload/science signal via respective optical waveguides, wherein temporal variations in the optical waveguides are indiscernible from atmospheric variations; a plurality of per-sub-aperture PID servos for receiving the DSM signal and payload/science signal from the optical waveguides and performing delay correction/compensation operations to remove atmospheric and temporal optical waveguide variations; a station reference clock and DSM (tracer) message decoder for receiving the DSM signal from the reference sub-aperture and outputting reference clock signals to the plurality of per-sub-aperture PID servos; an optical beamformer/summer for summing the optical payload and DSM signals from which atmospheric and temporal optical waveguide variations have been removed by the plurality of per-sub-aperture PID servos; and a calibration block for receiving the summed optical payload and DSM signals and generating and transmitting coherency calibration signals to the plurality of per-sub-aperture PID servos for establishing coherence between the optical payload and DSM signals output from the plurality of per-sub-aperture PID servos.

According to an aspect of this specification, a method of establishing coherence of an optical payload and DSM signals from a plurality of sub-apertures, from which atmospheric and temporal optical waveguide variations have been removed by a plurality of per-sub-aperture PID servos, comprising: opening a light path of a reference sub-aperture; and aligning the optical payload and DSM signals; and opening the light paths for all sub-apertures to obtain a beamformed sum of the DSM colour and payload colours.

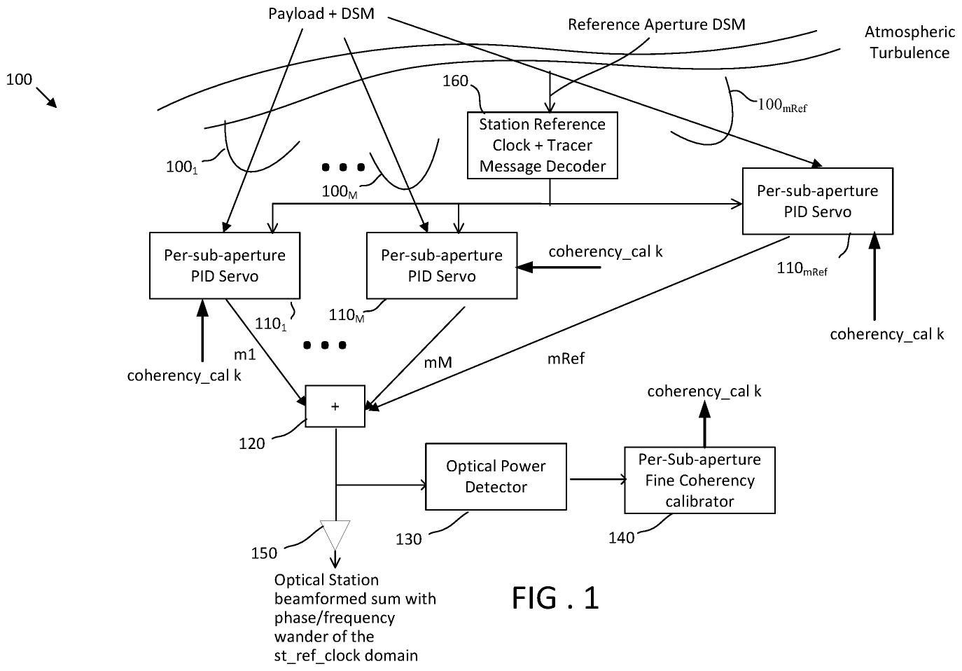

Turning to FIG. 1, a system 100 is shown for optical beamforming and interferometry using digital source modulation, in accordance with exemplary embodiments of the disclosure. A plurality of “sub-apertures” are provided in the form of mirrors (or sub-parts of a larger mirror) 100₁ . . . 100_{M}, 100_{mRef}, each of a size (Ro) such that the PSF (point-spread function) of the received DSM signal and payload/science signal is at its diffraction limit (note that there must be sufficient DSM signal power and sensitivity for each sub-aperture to independently lock onto the DSM signal). The DSM signal and payload/science signal may optionally be amplified by a low noise amplifier (not shown) for amplifying the total optical signal before processing by associated per-sub-aperture PID servos 110₁ . . . 110_{M}, 110_{mRef}, where “P” refers to proportional gain, “I” refers to integral gain, and “D” refers to derivative gain. Within each per-sub-aperture PID servo 110₁ . . . 110_{M}, 110_{mRef}, delay correction/compensation operations are performed to remove atmospheric and temporal optical waveguide variations.

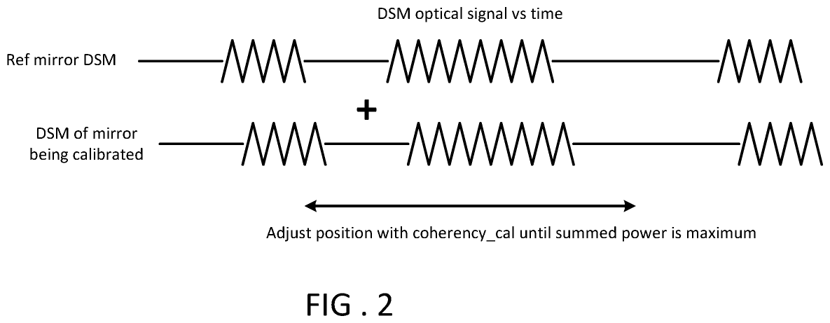

An optical beamformer/summer 120 adds the optical payload and DSM signal corrected for the atmosphere by the PID servos 110₁ . . . 110_{M}. 110_{mRef}. However, differential delays in the optics, electronics, and optical paths of the PID servos 110₁ . . . 110_{M}, 110_{mRef} are such that the outputs of the PID servos 110₁ . . . 110_{M}, 110_{mRef} do not add coherently at the optical wavelength. Thus, calibration block 130 establishes coherence. With the light path of the Reference sub-aperture 100_{mRef} open, the light path for each sub-aperture 100₁ . . . 100_{M} is opened sequentially thereby feeding the DSM signal/colour from beamformer/summer 120 into an optical power detector 130, which in embodiments can be a photo detector and ADC. The tracer DDS phase (“coherency_cal”) of the sub-aperture being calibrated is then adjusted in a per-sub-aperture fine coherency calibrator 140 until maximum optical power is detected. As shown in FIG. 2, maximum power is obtained when the optical carrier and DSM symbols are perfectly aligned. In embodiments, a sensitive peak-finding algorithm can be provided that combines a low-rate linear step/sweep and low-amplitude (e.g. few MHz) of sinusoidal modulation of the coherency_cal signal. Then, for each step, the few MHz modulation signal can be cross-correlated and integrated with the ADC output of optical power detector 130 until a peak in the Fourier Transform of the cross-correlation function (of the few MHz modulation) is found. It is contemplated that calibration may be possible without opening the optical light paths to the sub-apertures, by using a different modulation frequency simultaneously for each sub-aperture 100₁ . . . 100_{M} and searching for the peak in the cross-correlation function for each.

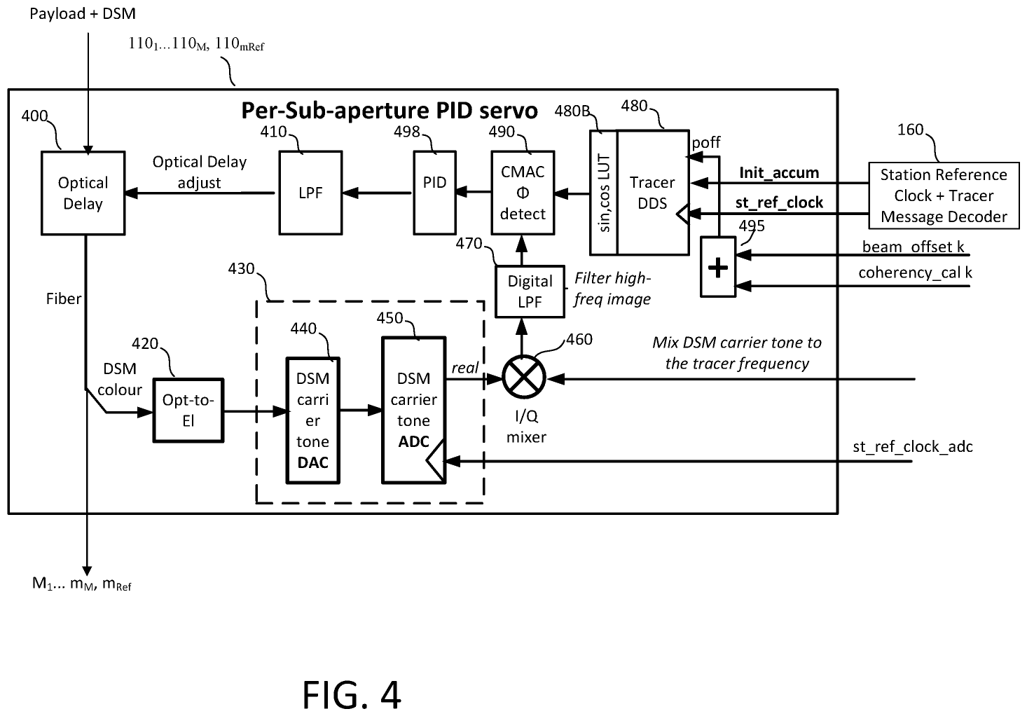

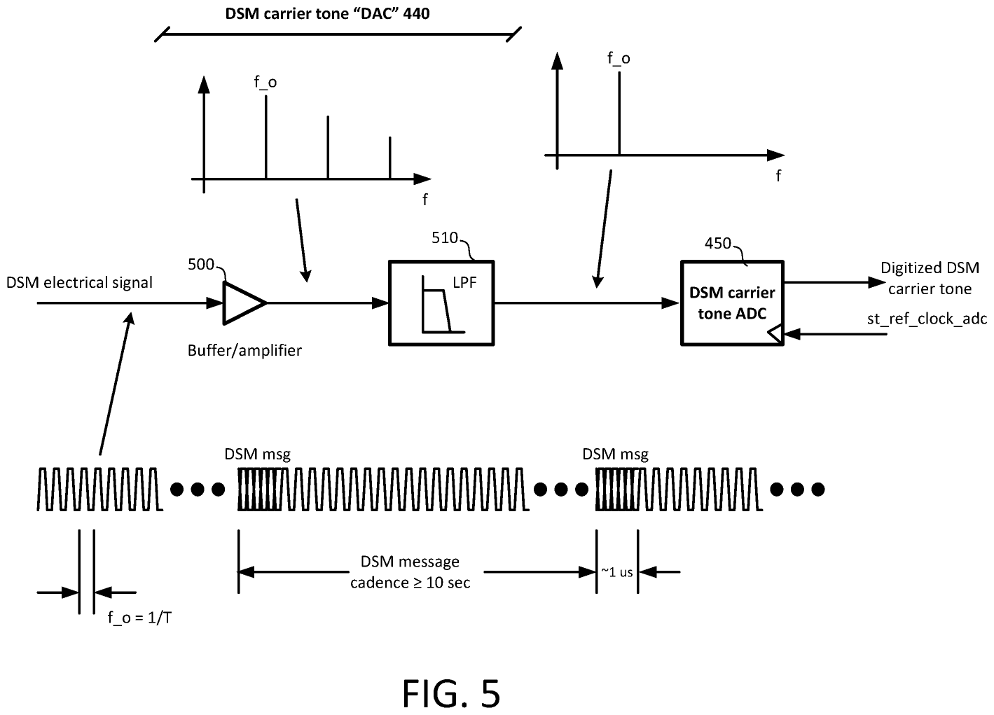

The coherency_cal signal is a phase offset into a tracer direct digital synthesizer, DDS 480, that offsets (i.e. biases) an optical delay 400, discussed below with reference to FIGS. 4 and 5, by a corresponding amount. A coherency_cal resolution of a fraction of an optical wavelength is required; for example for a 32-bit tracer DDS at a tracer frequency of 100 MHz, 1/(100 MHz×2\hat{ }32)˜=1e-18 sec of delay resolution can be obtained, depending on the transfer function of optical delay 400. For example, at an optical wavelength of 2=1500 nm, 1e-18 sec corresponds to an optical phase resolution of c/λ×1e-18 sec, or ˜0.072 degrees.

After coherency calibration, the optical signals' output from PID servos 110₁ . . . 110_{M}, 110_{mRef} must be differentially (i.e. every sub-aperture relative to all others) temporally stable in delay to a fraction of an optical wavelength. In each PID servo 110₁ . . . 110_{M}, 110_{mRef} this can be accomplished by length matching and temperature stabilizing all critical electrical paths. In practice, periodic coherency calibration may be required to ensure continued coherence.

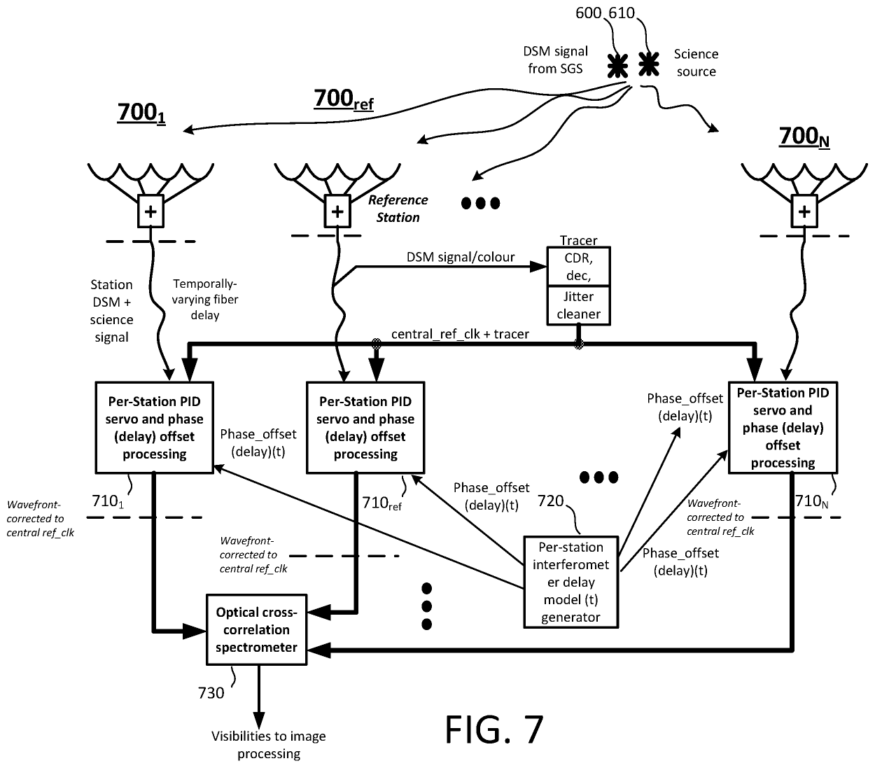

An optional low noise amplifier (LNA) 150 may be provided, although not required for sat-comm applications since the coherent beamformed signal is ready for payload extraction without it, whereas for astronomy aperture synthesis, LNA 150 may be required to drive additional optical paths, as discussed with reference to FIG. 7.

Once the coherency calibration procedure discussed above is performed for every sub-aperture, the light paths for all sub-aperture 100₁ . . . 100_{M}. 100_{mRef} are opened to obtain a final beamformed sum of the DSM colour and payload colours. This summed signal may then be subject to further payload extraction and processing (not shown), with the DSM signal either discarded or used for optical link performance monitoring.

Station reference clock and DSM (tracer) message decoder 160 receives the DSM colour output from reference sub-aperture 100_{mRef}, and outputs reference clock signals st_ref_clk and st_ref_clk_adc, to the PID servos 110₁ . . . 110_{M}, 110_{mRef}.

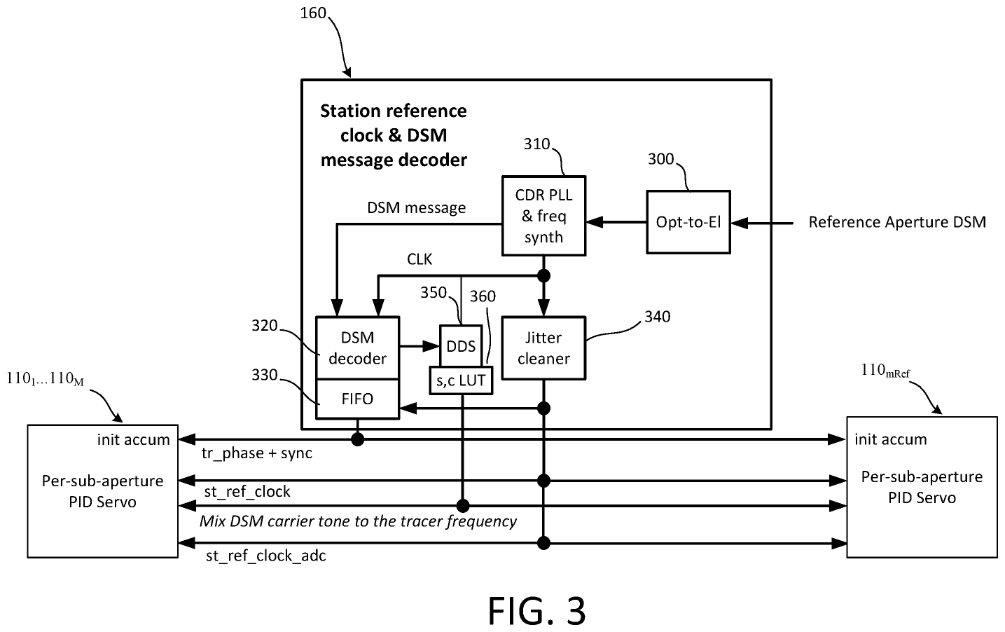

An exemplary station reference clock and DSM message decoder 160 is shown in FIG. 3. Optical-to-electrical (photo) detector 300 extracts the DSM colour from reference sub-aperture 100_{mRef} and converts it to an electrical (voltage) on/off signal. Clock-data-recovery (CDR) PLL and frequency synthesizer 310 extracts a clock from the DSM signal for decoding by DSM decoder 320 as tr_phase+sync and is written to a FIFO 330 for use in the st_ref_clock domain to periodically load/initialize the init_accum input of each PID servo 110₁ . . . 110_{M}, 110_{mRef}, as discussed with reference to FIG. 4. The st_ref_clock is a “digital quality” clock used for discrete digital operations of the PID servos 110₁ . . . 110_{M}, 110_{mRef}; its actual jitter has no impact on servo performance, other than meeting digital circuitry timing needs. However, the (differential) jitter performance of st_ref_clock_adc at each DSM carrier tone ADC 450 (FIG. 4) is important as it determines PID servo tracking performance in terms of loop bandwidth and optical wavelength operation, since it affects phase noise in the output of DSM carrier tone ADC 450. Typically st_ref_clock_adc needs to be better than ˜50 fsec RMS (differential) at each ADC clock input, depending on loop bandwidth and optical wavelength.

Jitter cleaner 340 cleans the raw output from CDR PLL frequency synthesizer 310 for use as the station reference clocks, st_ref_clock and st_ref_clock_adc, both the same frequency and phase, but with different qualities as described above. Jitter cleaner 340 can be a null function, or may cut off atmospheric phase variations of the DSM signal at a defined cutoff frequency.

Turning now to FIG. 4, additional details of each PID servo 110₁ . . . 110_{M}, 110_{mRef} are shown. Optical delay 400 is a pure single-axis optical delay, driven by an optical Delay adjust signal from low pass filter (LPF) 410, whose dynamic temporal and range response must be sufficient for atmospheric delay compensation, relative to the st_ref_clock produced by the jitter cleaner 340. Also, its transfer function (i.e. optical delay adjust voltage-to-delay transfer function) need not be precisely known since the PID servo loop compensates for it.

A copy of the DSM signal colour is fed through an optical-to-electrical demodulator 420 (i.e. ON/OFF photo detector) into a DAC/ADC block 430 of the per-sub-aperture PID servo, comprising a DSM carrier tone DAC 440 and DSM carrier tone ADC 450. A DSM-derived monochromatic tone (“carrier tone”) is captured within the DAC/ADC block 430 into the common digital clock domain st_ref_clock. The performance of block 430, in capturing the DSM carrier tone without systematic phase noise effects that are not due to the atmosphere, determines PID servo bandwidth performance (i.e. atmospheric correction speed) and the useful optical wavelength. FIG. 5 provides additional details of block diagram of block 430 and its operation, although other methods may be used to accomplish the same result.

In FIG. 5, the DSM signal, which is mostly a digital square wave but with periodic DSM message content (i.e. tracer), is buffered/amplified at 500 and filtered via LPF 510 to yield only the DSM signal fundamental frequency f_o, which is then digitized into the st_ref_clock(_adc) clock domain. As such, buffer/amplifier 500 and LPF 510 provide the functionality of DSM carrier tone DAC 440. DSM messages result in an increase in spectral content around f_o, resulting in a very short and inconsequential reduction in station beamforming coherence, which can be outside the PID servo loop bandwidth. It will be appreciated that the functionality illustrated in FIG. 5 may be accomplished by other methods and circuitry.

The output of ADC 450 is a “real” digitized sinusoid of the DSM carrier tone and therefore carries no phase information except that all sub-aperture outputs are at similar phases within ˜π/8 of each other so there is no phase ambiguity when it comes to “coherency calibration”, as discussed further below. In order to provide phase for calibration, beamforming, and station beam steering, the “real” digitized sinusoid of the DSM carrier tone must be turned into a complex signal by an I/Q mixer 460, with a complex sinusoidal input whose phase and frequency is extracted from the periodically-transmitted DSM message (tracer), which is generated by DDS 350 in station reference clock and DSM message decoder 160 (FIG. 3). The result of this operation is complex, with tones in the complex frequency domain at the DSM carrier tone+/−the I/Q mixer frequency, with one (i.e. generated by DDS 350) at the DSM tracer frequency, and another at a higher frequency, which must be digitally filtered out via digital LPF 470, before a CMAC ϕ detector 490 (where CMAC==Complex Multiply-Accumulate). Alternatively, the complex output of complex multiplier in detector 490 can be digitally filtered before accumulation. By making the unwanted complex image a substantially different frequency than the wanted image, the digital LPF filter 470 can be optimized in terms of hardware and latency. For example, if the DSM carrier tone f_o is 150 MHz and the tracer produced by DDS 480 is 100 MHZ, then the I/Q mixer frequency is 50 MHz, with one output at 100 MHz and one at −200 MHz, with the latter filtered by the digital LPF 470.

A digital phase ramp output from tracer DDS 480 is converted to digital sine and cosine via a LookUp Table (LUT 480B), before use in the CMAC detector 490, where the phase and frequency is the same for each sub-aperture (and station): for the former, periodic messages encoded in the DSM signal (i.e. DSM tracer messages) update its phase so that all sub-apertures and stations are aligned, with only the atmosphere across them different; for the latter, each tracer DDS 480 operates with the same system-wide phase increment.

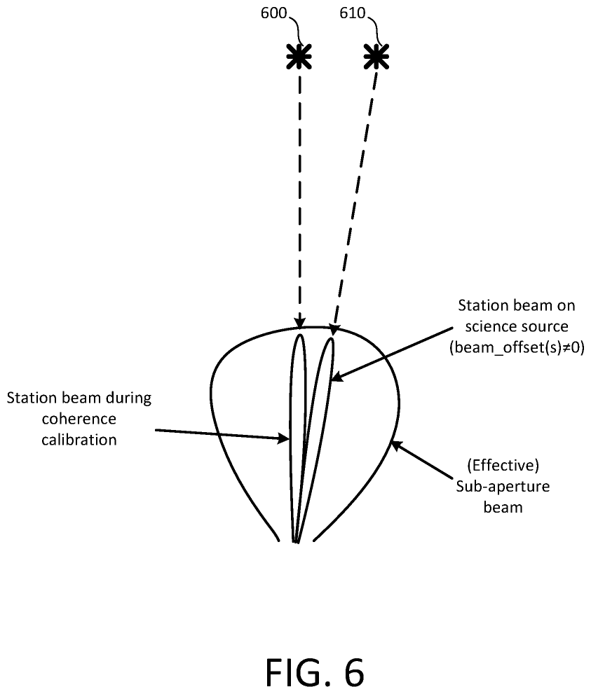

Inputs to the phase offset (“poff”) of the tracer DDS 480 include the coherency_cal signal and the beam_offset, which are both digital values that are summed at 495. The coherency_cal signal comes from the per-sub-aperture calibration process discussed above in connection with the per-sub-aperture fine coherency calibrator 140. The beam_offset is set differently for each sub-aperture (i.e. “delay-and-sum” beam steering) to steer the station beam to the payload/science source, if needed, as discussed below with reference to FIG. 6. Both the coherency_cal signal and the beam_offset signal bias the optical delay 400 to achieve station beam coherence, but steered in the direction of the science/payload target. For sat-comm applications, typically beam_offset=0 since the DSM signal and the optical payload are transmitted from the same source, whereas for optical astronomy beam_offset≠0 since the science target source is not the DSM source.

The output of DDS 480 and LUT 480B is connected to a PID 498, for calculating the PID coefficients, accumulating the result and outputting to a LPF 410 which filters out any phase variations and phase noise that are on timescales faster than the atmosphere correction time, Tau_atm, to produce an “Optical Delay adjust” signal. LPF 410 may be digital or analogue, or be inherent in the frequency response of the Optical Delay.

The Optical Delay adjust signal drives the optical delay 400, thereby completing the per-sub-aperture PID servo loop 110₁ . . . 110_{M}, 110_{mRef}, such that the loop tracks and removes the effects of atmospheric fluctuations on the DSM signal and in so doing, the optical payload signals as well.

Turning now to FIG. 6, station beam offset is depicted, which is normally only required for astronomy applications. The DSM signal from a satellite guide star (SGS) 600, is offset from the astronomy science source 610. With a non-zero beam_offset, coherence is established and maintained on the DSM signal, whilst the actual station beam is pointed to the science source 610. The degree of offset determines science source coherence, since its photons traverse a different atmosphere than the DSM signal.

For optical astronomy aperture synthesis (interferometry), as shown in FIG. 7, each station 700₁ . . . 700_{ref} . . . 700_{N} corresponds to a system 100 as shown in FIG. 1, wherein the output of each station comprises a beamformed sum of the DSM colour and payload colours for each station, with each wavefront-corrected to each st_ref_clk independently, and with small unknown delay offsets that can be calibrated by correlating on an astronomical calibrator, as discussed below, with delay adjusted to obtain fringes at 0-delay. Reference station 700_{ref} is preferably positioned near the array phase center.

Blocks 710₁ . . . 710_{ref} . . . 710_{N} are similar to per-sub-aperture PID servos 110 in FIG. 4, except that the optical delay 400 contains delay to perform final atmospheric delay compensation of each station 700₁ . . . 700_{N} to the smoothed central_ref_clk+tracer signal from reference station 700_{ref}, and the full range of wavefront delay compensation required as the astronomical science source tracks at the sidereal rate across the sky. The latter can be implemented, for example, with a binary sequence of fiber lengths (e.g. on spools), with lengths switched in and out such that the error in total optical delay is sufficiently small, typically ˜10 degrees RMS at the optical wavelength. It should be noted that since the DSM and science signal go through the same delay path, each PID servo block 710₁ . . . 710_{ref} . . . 710_{N} compensates for any temporal variations or absolute uncertainties, and the delay can be implemented, relative to a common geographical point (known at the array “phase-center”, typically a virtual physical point near the geometric center of the array), on a per-station basis, resulting in a significant improvement over the prior art per-baseline (i.e. antenna pair) requirement in optical interferometry. In each PID servo block 710₁ . . . 710_{ref} . . . 710_{N}, the optical delay has a much larger range (i.e. fiber cable segments+short-range dynamic) and may be temporally varying. Only the st_ref_clk to central_ref_clk phase wander and delay tracking is required to be accommodated.

A wavefront geometrical delay model is applied to each PID servo block 710₁ . . . 710_{ref} . . . 710_{N} via per-station interferometer delay model (t) generator 720, for applying a model of the delay phase_offset (delay)(t) within each PID servo block 710₁ . . . 710_{ref} . . . 710_{N}. Since the delay range that must be accommodated, many cycles of the DSM tracer frequency are required, for example 100 MHz, introducing a phase ambiguity problem. To deal with this, the DSM message contains one or more lower tracer frequency phase “init_accum” messages, for one or more lower tracer frequency DDSs (not shown), used to resolve this issue with the PID servo block 710 closing the loop on all of these frequencies simultaneously, and a “beam_offset” developed for each one, depending on the delay range it can capture without phase ambiguity. For example, if a 1 kHz ultra-low-frequency tracer is used, with a period T__{If_tracer} of 1 msec, it can be used to resolve the phase ambiguity up to ˜+/−T__{If_tracer}/8 or +/−125 microseconds. Here, the 1 kHz servo phase accuracy need only be such that it is within the high frequency tracer (e.g. 100 MHZ) phase ambiguity “capture range.” For this low-frequency, low-accuracy tracer, all-digital processing may be employed instead of analogue/digital processing as depicted in FIG. 5, wherein the DAC 440 comprises a DDS and its output digital phase ramp is captured into the st_ref_clock domain using all-digital clock-domain crossing methods.

The output of each PID servo block 710₁ . . . 710_{ref} . . . 710_{N} is a DSM and science signal that is fully atmosphere-compensated and wavefront-delayed and ready for cross-correlation in an optical cross-correlation spectrometer 730. These signals need to be stable, but only inasmuch as any differential variation in them can be removed by optical cross-correlation spectrometer 730 using astronomical point-source calibration. The optical cross-correlation spectrometer 730 produces visibilities for each pair of stations (i.e. “baseline”) in the array. Since the (wavefront) geometrical delay model applied to each PID servo block 710₁ . . . 710_{ref} . . . 710_{N} via per-station inferometer delay model (t) generator 720 is merely a model of the delay, and not the actual delay at the time of observing, the cross-correlation function must be adequately sampled in relative delay so that any residual (i.e. difference between the actual delay and the model) can be captured and corrected during visibility (image) processing. Thus, the optical cross-correlation spectrometer 730 must be able to capture relative phase and delay information between each pair of stations being processed.

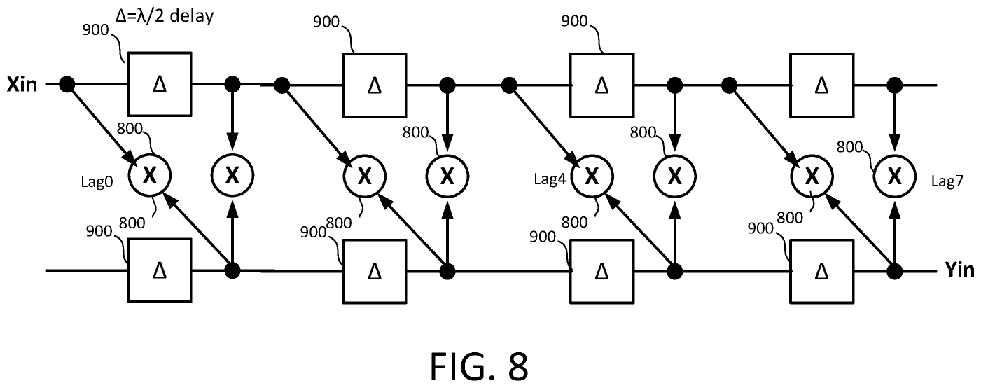

Details of an exemplary optical cross-correlation spectrometer 730 are shown in FIG. 8, in the form of a “lag” correlator, as is known in the art, having a plurality of optical-optical multipliers 800 and delays 900, where delay=λ/2. Input signals Xin and Yin are received from the two stations (X and Y) being cross-correlated such that optical-optical multiplier 800 produce an output that is the beat-difference-frequency of Xin and Yin, in the form of a voltage ranging from DC to up to ˜1 kHz (depending on the required image field of view), typically digitized with an ADC of sufficient precision (not shown), and then digitally accumulated for a prescribed period of time. Although a lag correlator is shown in FIG. 8, it is contemplated that other methods for a real cross-correlation to produce complex visibilities may be used.

The Fourier-transform of these accumulated lag points is the complex cross-power spectrum of the two stations being cross-correlated, with the number of unique frequency points being ½ the number of lags. A delay residual appears as a phase-slope in the cross-power spectrum, which can be periodically measured on a continuum astronomical source calibrator, and applied to the astronomical science source during image processing, which is a method well-established in the radio astronomy literature.

The DSM signal is effectively a narrow-band interference (i.e. “RFI”) signal that forms a peak in the cross-correlation spectrum, suppressed somewhat proportional to the geographical separation of the two stations X and Y and the offset of the SGS 600 from the astronomical science source. In some embodiments, the signal may be notch-filtered out of the total optical signal before correlation which, as is known, produces a spectral hole in the science source spectrum.

The description of exemplary embodiments of the present disclosure provided below is merely exemplary and is intended for purposes of illustration only; the following description is not intended to limit the scope of the invention disclosed herein. Moreover, recitation of multiple embodiments having stated features is not intended to exclude other embodiments having additional features or other embodiments incorporating different combinations of the stated features.

The present invention has been described above with reference to a number of exemplary embodiments and examples. It should be appreciated that the particular embodiments shown and described herein are illustrative of the invention and its best mode and are not intended to limit in any way the scope of the invention as set forth in the claims. The features of the various embodiments may stand alone or be combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. These and other changes or modifications are intended to be included within the scope of the present invention, as expressed in the following claims.

1. A system for optical beamforming and interferometry using digital source modulation, comprising
a plurality of sub-apertures, including a reference sub-aperture, for receiving and transmitting a digital source modulation (DSM) signal and payload/science signal via respective optical waveguides, wherein temporal variations in the optical waveguides are indiscernible from atmospheric variations;
a plurality of per-sub-aperture PID servos for receiving the DSM signal and payload/science signal from the optical waveguides and performing delay correction/compensation operations to remove atmospheric and temporal optical waveguide variations;
a station reference clock and DSM (tracer) message decoder for receiving the DSM signal from the reference sub-aperture and outputting reference clock signals to the plurality of per-sub-aperture PID servos;
an optical beamformer/summer for summing the optical payload and DSM signals from which atmospheric and temporal optical waveguide variations have been removed by the plurality of per-sub-aperture PID servos; and
a calibration block for receiving the summed optical payload and DSM signals and generating and transmitting coherency calibration signals to the plurality of per-sub-aperture PID servos for establishing coherence between the optical payload and DSM signals output from the plurality of per-sub-aperture PID servos.

2. The system of claim 1, wherein for sat-comm applications the DSM signal comprises at least one optical colour of a Dense Wavelength Division Multiplexing signal, with other colours of the Dense Wavelength Division Multiplexing signal being high data rate communications payload.

3. The system of claim 1, wherein for astronomy applications the DSM signal comprises a laser signal transmitted by an optical satellite guide star, with an orbit that allows a sufficient period of time close to a science target to be used as a calibrator.

4. The system of claim 2, wherein the DSM signal comprises a digital square wave with periodic DSM message content, and further comprising an DAC/ADC block for extracting a DSM signal fundamental frequency from the DSM signal which is digitized into the reference clock signal domain to allow synchronized production, at each sub-aperture of a high-purity complex digital monochromatic tracer signal that follows the same optical path as the payload/science signal such that any delay differences in the DSM signal at each sub-aperture also apply to the payload/science signal.

5. The system of claim 1, wherein the station reference clock and DSM (tracer) message decoder comprises:
an optical-to-electrical (photo) detector for extracting the DSM signal from the reference sub-aperture and converting the extracted DSM signal to an electrical (voltage) on/off signal;
a clock-data-recovery (CDR) phase-lock-loop (PLL) and frequency synthesizer for extracting a clock from the DSM signal;
a direct digital synthesizer for periodically generating a complex digital tracer;
a DSM decoder for decoding the extracted clock and generating an initialization signal to periodically load/initialize an input of each per-sub-aperture PID servo; and
a jitter cleaner for cleaning the output from the CDR PLL frequency synthesizer and generating station reference clock signals for discrete digital operations of the plurality of per-sub-aperture PID servos.

6. The system of claim 5, wherein each per-sub-aperture PID servo comprises:
an optical delay for receiving the DSM signal and payload/science signal;
an optical-to-electrical demodulator for receiving a copy of the DSM signal and generating a DSM-derived monochromatic tone;
a DAC/ADC block for capturing the DSM-derived carrier tone into the digital domain station reference clock signals and generating a real digitized sinusoid of the DSM carrier tone;
an I/Q mixer for receiving the real digitized sinusoid of the DSM carrier tone and a complex sinusoidal input whose phase and frequency is extracted from the complex digital tracer generated by the direct digital synthesizer of the station reference clock and DSM (tracer) message decoder, and outputting a first complex frequency domain tone at a DSM tracer frequency and a second higher complex frequency domain tone;
a low pass filter for digitally filtering the second higher complex frequency domain tone;
a tracer direct digital synthesizer for receiving the initialization signal from the DSM decoder, the station reference clock signals and a phase offset signal and outputting a digital phase ramp;
a look-up table for converting the digital phase ramp to digital sine and cosine signals;
a complex accumulator and multiplier for multiplying the filtered second higher complex frequency domain tone and digital sine and cosine signals and generating a complex output whereby periodic messages encoded in the DSM signal update the phase of the DSM signal so that all sub-apertures and stations are aligned; and
a low pass filter for filtering any phase variations and phase noise in the complex output from the complex accumulator and multiplier that is on timescales faster than the atmosphere correction time and generating an optical delay adjustment signal for driving the optical delay thereby removing the effects of atmospheric fluctuations on the DSM and payload/science signals.

7. The system of claim 6, wherein the optical delay comprises a pure single-axis optical delay.

8. The system of claim 6, wherein the DAC/ADC block comprises a DSM carrier tone DAC and DSM carrier tone ADC.

9. The system of claim 6, further including a summer for summing the coherency calibration signals from the calibration block and beam offset signals to steer the station beam to the sub-aperture source of the payload/science signal and generating the phase offset signal for driving the tracer direct digital synthesizer.

10. A method of establishing coherence of an optical payload and DSM signals from a plurality of sub-apertures, from which atmospheric and temporal optical waveguide variations have been removed by a plurality of per-sub-aperture PID servos, comprising:
opening a light path of a reference sub-aperture;
aligning the optical payload and DSM signals; and
opening the light paths for all sub-apertures to obtain a beamformed sum of the DSM colour and payload colours.

11. The method of claim 10, wherein aligning the optical payload and DSM signals comprises sequentially opening a light path for each other sub-aperture and adjusting the phase of the DSM signals until maximum optical power is detected, whereby the optical payload and DSM signals are aligned

12. The method of claim 11, wherein the maximum optical power is detected by sweeping a sinusoidal modulation of a coherency calibration signal, cross-correlating the detected maximum optical power with the sinusoidal modulation frequency for determining coherence as a peak in the cross-correlation function, at a particular sweep step.

13. A method of establishing coherence of an optical payload and DSM signals from a plurality of sub-apertures, from which atmospheric and temporal optical waveguide variations have been removed by a plurality of per-sub-aperture PID servos, comprising:
opening a light path of a reference sub-aperture; and
aligning the optical payload and DSM signals; and
using a different swept sinusoidal modulation frequency simultaneously for each of the plurality of sub-apertures and searching for a peak in the cross-correlation function, at a particular sweep step, for each sub-aperture simultaneously.

14. A system for optical astronomy aperture synthesis, comprising:
a plurality of stations for beamforming and interferometry using digital source modulation, as claimed in the system of claim 3, wherein the output of each station comprises a beamformed sum of the DSM signal and science signal for each station, with each wavefront-corrected to each station reference clock independently, and wherein a reference station is preferably positioned near the array phase center of the plurality of stations;
a plurality of per-station PID servo and phase offset processor blocks for performing atmospheric delay compensation and wavefront delay compensation of the DSM signal and science signal for each of the plurality of stations to a smoothed central reference tracer signal from the reference station; and
one or more lower tracer frequency direct digital synthesizers to resolve phase ambiguities in the DSM signal;
an optical cross-correlation spectrometer for cross-correlating the atmosphere-compensated and wavefront-delayed DSM signal and science signal from each of the per-station PID servo and phase offset processor blocks; and
a per-station inferometer delay model (t) generator for applying a wavefront geometrical delay model to each of the per-station PID servo and phase offset processor blocks.

15. The system of claim 14, wherein the optical cross-correlation spectrometer comprises
a lag correlator having correlator having a plurality of optical-optical multipliers and delays, where delay=λ/2, for receiving and cross-correlating a pair of signals of wavelength λ from a pair of the stations such that each optical-optical multiplier produces an output that is the beat-difference-frequency of the pair of signals;
an ADC of sufficient precision for converting the output to a digital output signal; and
an accumulator for accumulating the digital output signal for a period of time, wherein the Fourier-transform of the accumulated digital output signal is the complex cross-power spectrum of the pair of signals being cross-correlated, with the number of unique frequency points being ½ the number of delays.

16. The system of claim 15, wherein the output is in the form of a voltage whose frequency is dependent on required image field of view.

17. The system of claim 16, wherein voltage ranges from DC to up to ˜1 kHz.

18. The system of claim 15, wherein the DSM signal comprises a narrow-band interference (RFI) signal that forms a peak in the cross-correlation spectrum, suppressed proportional to the geographical separation of the pair of stations and the offset of the optical satellite guide star from the sub-aperture source of the science signal, and further comprising a notch filter connected to an input of the lag correlator for filtering the narrow-band interference (RFI) signal.

19. The system of claim 3, wherein the DSM signal comprises a digital square wave with periodic DSM message content, and further comprising an DAC/ADC block for extracting a DSM signal fundamental frequency from the DSM signal which is digitized into the reference clock signal domain to allow synchronized production, at each sub-aperture of a high-purity complex digital monochromatic tracer signal that follows the same optical path as the payload/science signal such that any delay differences in the DSM signal at each sub-aperture also apply to the payload/science signal.
